(19) United States
(12) Patent Application Publication
(10) Pub. No.: US 2006/0053110 A1
(43) Pub. Date: Mar. 9, 2006

(54) Out-of-home advertising inventory ratings methods and systems

(75) Inventors: William Jacobus McDonald, Philadelphia, PA (US); Thomas Jay Adler, Norwich, VT (US); Stephen J.C. Lawe, Etna, NH (US); Wendy Elizabeth Welles, Ellicott City, MD (US); Michael Edward McCoy, Columbia, MD (US)

Correspondence Address: Attention: PATENTS;COWAN, LIEBOWITZ & LATMAN, P.C., 1133 AVENUE OF THE AMERICAS, NEW YORK, NY, 10036, US

(73) Assignee: Arbitron Inc.

(21) Appl. No.: 11/219,453

(22) Filed: Sep. 2, 2005

Related U.S. Application Data
(60) Provisional application No. 60/607,084, filed on Sep. 3, 2004.

(51) Int. Cl. G06F 17/30

(52) U.S. Cl. 707/6

(57) ABSTRACT

Methods, systems and programs for estimating exposure to outdoor advertising are provided. In certain embodiments, exposure data is produced based on respondent data and traffic data. In certain embodiments, exposure data is produced based on outdoor inventory data and traffic data.

### RELATED APPLICATION

This application claims priority to U.S. provisional patent application Ser. No. 60/607,084, filed Sep. 3, 2004, which is hereby incorporated herein by reference in its entirety.

### FIELD OF THE INVENTION

The present invention concerns methods and systems for estimating exposure to outdoor advertising media.

### BACKGROUND OF THE INVENTION

For the most part, inventory exists on a road, on a moving vehicle, in a rail or bus station, in an airport or along a city street. In developing a media ratings service, typically the researcher measures exposure to media type or, more precisely, endeavors to measure and report on the behavior of media usage. For broadcast, print, and online research, the somewhat insular world of the media researcher is quite sufficient for developing an audience measurement service. Media researchers know how to research media behavior. But in Out-of-Home advertising, the relevant behavior to measure is not readership, viewing, or even media consumption generally in the traditional sense. Rather, the relevant behavior is traffic behavior: how people move through and use the travel grid within a market.

But statistically reliable measures of traffic behavior at the level of individual persons are unavailable in all but a very few markets. Until now, measures of exposure to inventory in markets where such information is unavailable have not provided useful estimates at a level of detail that enables advertisers and media organizations to compare the effectiveness of outdoor advertising with, for example, broadcast media advertising. The absence of such information has made it very difficult to price the value of outdoor advertising in a way that is comparable to other forms of advertising media.

Thus, it would be advantageous to provide a system and method to implement an Out-of-Home advertising ratings service that affords reliable estimates of exposure to inventory at the level of detail available for other forms of advertising media, such as broadcast media.

### SUMMARY OF THE INVENTION

For this application the following terms and definitions shall apply:

The term “data” as used herein means any indicia, signals, marks, symbols, domains, symbol sets, representations, and any other physical form or forms representing information, whether permanent or temporary, whether visible, audible, acoustic, electric, magnetic, electromagnetic or otherwise manifested. The term “data” as used to represent predetermined information in one physical form shall be deemed to encompass any and all representations of the same predetermined information in a different physical form or forms.

The terms “transportation analysis zone” and “TAZ” as used herein each mean a geographic area, such as a municipal, county or city district, an area defined by a postal code or otherwise designated, whether for the purpose of transportation modeling or analysis or otherwise useful in estimating exposure to outdoor advertising media.

The terms “road segment” and “segment” as used herein each mean a stretch of road or other transportation pathway, such as a portion of a rail line, subway line, bus route, pedestrian walkway, ferry route or the like, usually between points such as intersections, stops, stations, markers, interchanges, signs or other geographic features, coordinates, vectors or other data corresponding to geographic locations.

The term “link” as used herein refers to a road segment used in or associated with a transportation model.

The term “inventory” as used herein means any and all forms of outdoor advertising display media, comprising billboards, posters, signs, banners and other forms of display media viewable from a road segment.

The terms “O-D pair” and “O-D” as used herein each mean an origin TAZ and destination TAZ pair that, along with a path, defines a trip taken in a transportation model.

The term “path” as used herein means a set of links that define a route from an origin TAZ to a destination TAZ.

The terms “Production-to-Attraction trip” and “P-A” as used herein each mean a trip from a producer (e.g. a home) to an attractor (e.g. a place of work, shopping or other out-of-home activity).

The terms “Attraction-to-Production trip” and “A-P” as used herein each mean a trip returning from an attractor back to a producer.

The term “reach” as used herein means the number of unique persons exposed to a piece of inventory.

The terms “exposure” and “gross impressions” as used herein each mean the total number of person exposures to a piece of inventory, counted in each instance whether or not the person exposed had previously been exposed to the same piece of inventory.

The term “frequency” as used herein means the average number of times an individual person is exposed to a piece of inventory, or a collection of pieces of inventory, which in certain embodiments is derived by dividing gross impressions by reach.

The terms “gross rating point” and “GRP” as used herein each mean a percentage of a population exposed to a piece of inventory, which in certain embodiments is derived by dividing gross impressions by the population number and multiplying the result by 100.

The term “O-D matrix” as used herein means a collection of all possible permutations of O-D pairs of TAZs.

The term “node” as used herein means a beginning or end of a link.

The terms “respondent” and “participant” as used herein each mean an individual participating in a market survey or other activity serving to provide individual-level data used to produce estimates of exposure to inventory.

The term “network” as used herein includes both networks and internetworks of all kinds, including the Internet, and is not limited to any particular network or inter-network.

The terms “first” and “second” are used to distinguish one element, set, data, object or thing from another, and are not used to designate relative position or arrangement in time.

The terms “coupled”, “coupled to”, and “coupled with” as used herein each mean a relationship between or among two or more devices, apparatus, files, programs, media, components, networks, systems, subsystems, and/or means, constituting any one or more of (a) a connection, whether direct or through one or more other devices, apparatus, files, programs, media, components, networks, systems, subsystems, or means, (b) a communications relationship, whether direct or through one or more other devices, apparatus, files, programs, media, components, networks, systems, subsystems, or means, and/or (c) a functional relationship in which the operation of any one or more devices, apparatus, files, programs, media, components, networks, systems, subsystems, or means depends, in whole or in part, on the operation of any one or more others thereof.

The terms “communicate” and “communication” as used herein include both conveying data from a source to a destination, and delivering data to a communications medium, system or link to be conveyed to a destination.

The term “processor” as used herein means one or more processing devices, apparatus, programs, circuits, systems and subsystems, whether implemented in hardware, software or both.

The terms “storage” and “data storage” as used herein mean data storage devices, apparatus, programs, circuits, systems, subsystems and storage media serving to retain data, whether on a temporary or permanent basis, and to provide such retained data.

In accordance with an aspect of the present invention, a method is provided for estimating exposure to outdoor advertising. The method comprises receiving respondent data representing movements of participants in a study, receiving traffic data representing actual or predicted movement patterns of traffic within a geographic region, and producing exposure data representing estimations of exposures to outdoor advertising based on the respondent data and the traffic data.

In accordance with another aspect of the present invention, a method is provided for estimating exposure to outdoor advertising. The method comprises receiving outdoor inventory data identifying locations of a plurality of outdoor advertisements within a geographic region, receiving traffic data representing actual or predicted movement patterns of traffic within a geographic region, and producing exposure data representing exposures to each of the outdoor advertisements based on the outdoor inventory data and the traffic data.

In accordance with a further aspect of the present invention, a system is provided for estimating exposure to outdoor advertising. The system comprises a processor operative to receive respondent data representing movements of participants in a study, operative to receive traffic data representing actual or predicted movement patterns of traffic within a geographic region, and operative to produce exposure data representing estimations of exposures to outdoor advertising based on the respondent data and the traffic data.

In accordance with an additional aspect of the present invention, a system is provided for estimating exposure to outdoor advertising. The system comprises a processor operative to receive outdoor inventory data identifying locations of a plurality of outdoor advertisements within a geographic region, operative to receive traffic data representing actual or predicted movement patterns of traffic within a geographic region, and operative to produce exposure data representing exposures to each of the outdoor advertisements based on the outdoor inventory data and the traffic data.

In accordance with yet a further aspect of the present invention, a program is provided for estimating exposure to outdoor advertising. The program, residing in storage, is operative to control a processor to receive respondent data representing movements of participants in a study, to receive traffic data representing actual or predicted movement patterns of traffic within a geographic region, and to produce exposure data representing estimations of exposures to outdoor advertising based on the respondent data and the traffic data.

In accordance with yet another aspect of the present invention, a program is provided for estimating exposure to outdoor advertising. The program, residing in storage, is operative to control a processor to receive outdoor inventory data identifying locations of a plurality of outdoor advertisements within a geographic region, to receive traffic data representing actual or predicted movement patterns of traffic within a geographic region, and to produce exposure data representing exposures to each of the outdoor advertisements based on the outdoor inventory data and the traffic data.

### BRIEF DESCRIPTION OF THE DRAWINGS

FIG. 1 is a data flow diagram illustrating data inputs to selected processes in accordance with certain embodiments of the present invention;

FIG. 2 is an exemplary depiction of a geographic area having a transportation network that is the subject of a transportation model;

FIGS. 3A through 3D depict exemplary O-D matrices;

FIGS. 4A and 4B together provide a flow diagram illustrating selected processes in accordance with certain embodiments of the present invention;

FIG. 5 illustrates an example of how a segment is traversed to produce data in accordance with certain embodiments of the present invention;

FIG. 6 illustrates a reach curve of a Negative Binomial Model; and

FIG. 7 is a block diagram of a system in accordance with certain embodiments of the present invention.

### DETAILED DESCRIPTION OF CERTAIN ADVANTAGEOUS EMBODIMENTS

In various described embodiments, market survey methods and systems employ data representing the movements of market survey participants or respondents within a geographic region or market, along with traffic data (empirical, modeled or both) to provide useful estimates of exposures to outdoor advertising. In certain embodiments, based upon data representing demographic characteristics of a relevant population in the region or market and data representing the movements of the market survey participants or respondents, as well as comparisons of empirical traffic data and modeled traffic data over the region or market, useful estimates of exposure of the population to advertising media broken down by demographic groups and time periods are produced. In certain embodiments, estimates of exposure to outdoor advertising media are projected for selected time periods.

Transportation Models

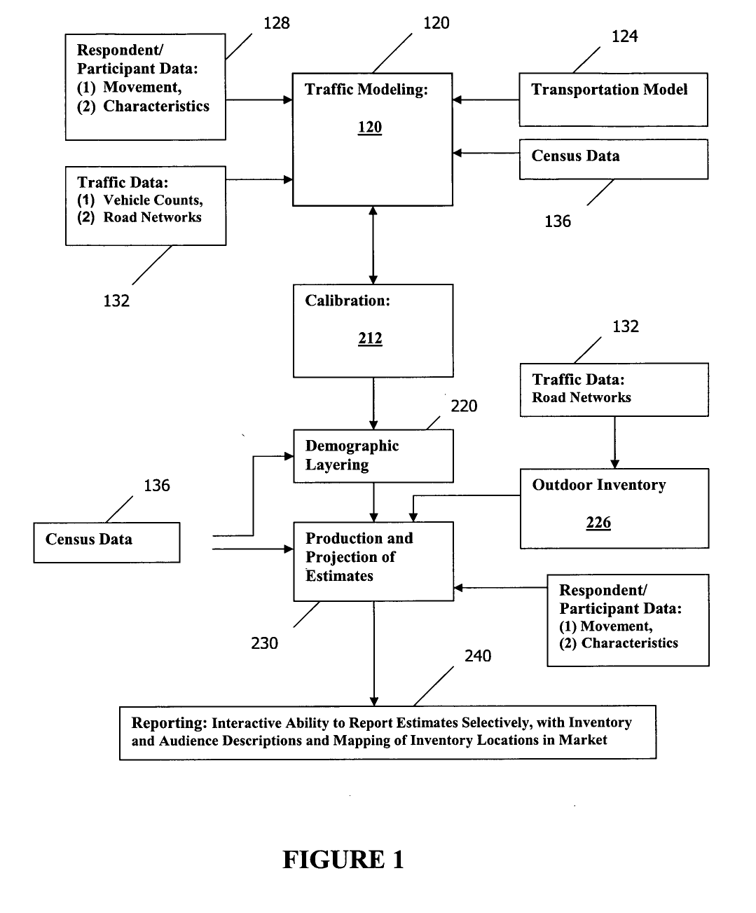

FIG. 1 is a flow chart illustrating an overall method in accordance with certain embodiments of the invention, together with various sources of data employed therein. The disclosed embodiments of the invention derive estimates of exposure to inventory in part by adapting transportation models developed to provide projections of traffic volume in a given geographic area for purposes of planning transportation systems. Input of data from such a transportation model is indicated in FIG. 1 at 124.

Over the years, numerous transportation models have been developed covering a great many urban areas throughout the world. A transportation model exists for all of the major U.S. metropolitan regions. These models are usually built over several years and cost millions of dollars. The data collection and estimation process is rigorous. Each such model in the United States must comply with Federal Highway Administration (FHWA) guidelines. The models are used to plan major roadway investments and allocate federal highway dollars.

Models differ in their capabilities, such as support for time-of-day modeling and definition of trip types. The geographic boundaries of these models usually encompass the Metropolitan Planning Organization (MPO) area or the Regional Planning Commission (RPC) towns. Transportation models disaggregate the entire model area into TAZs for the purposes of modeling. The model's geographic area is rarely sufficient by itself to provide useful data for estimating exposure to inventory in a corresponding media market.

Rather than enhance the transportation models as they are, the various embodiments extract a plurality of files or other data structures and utilize these, along with other data (as described hereinbelow) to extend the geographic scope of the modeled area (referred to herein as an outdoor model extension process or OMEP) and produce a revised model capable of providing exposure estimates for inventory within the extended model area with demographic and time period breakdowns comparable to estimates for other forms of competitive advertising media. One advantage of this approach is that as the transportation models change, newly created data are extracted and the OMEP can be rerun. In addition, due to OMEP, the various embodiments of the invention provide scalable and reusable solutions as one moves from region to region. The data extracted from the transportation models include: i. Land use file for each TAZ (residential, business, etc.); ii. Vehicle trip matrix file between TAZs (origin-destination matrix or O-D matrix); iii. Road network file (link and node); iv. Vehicle or person-trips by trip type originating at each TAZ; v. Delay parameters (prohibitions and other delays); and vi. Traffic counts.

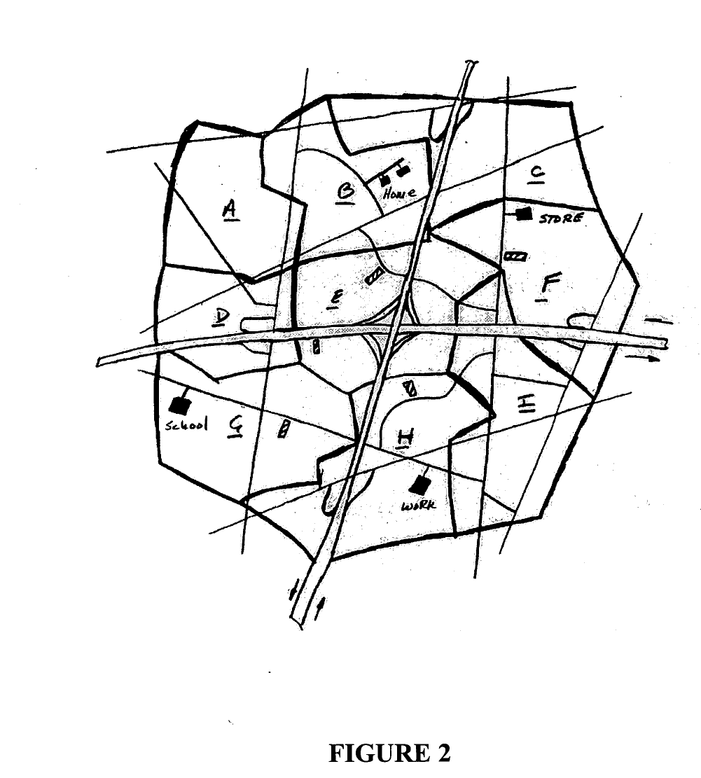

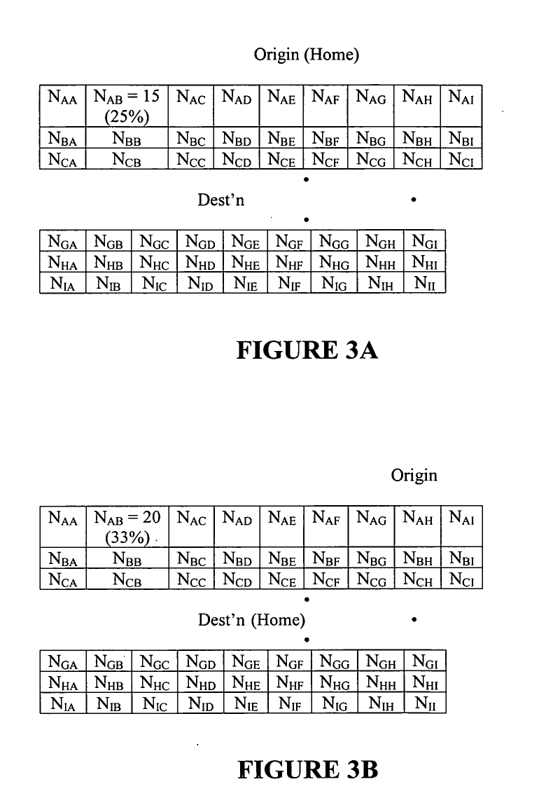

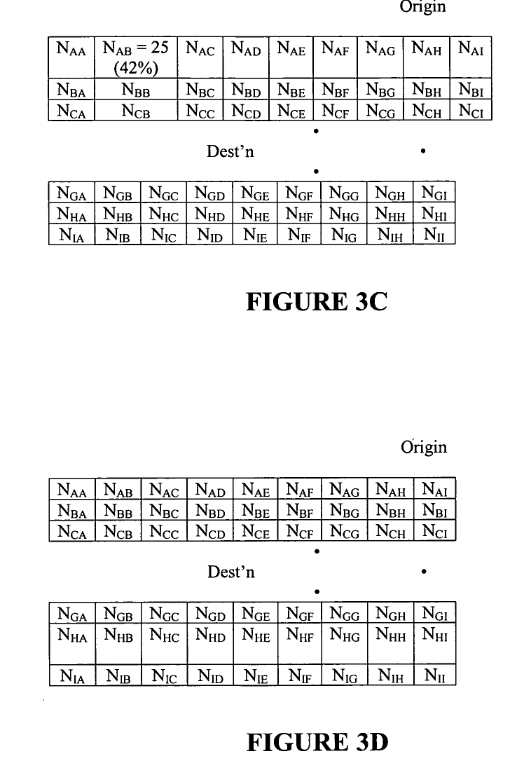

FIG. 2 provides an example of a modeled area divided into TAZ's A through I, on which a road network of limited access highways, collector roads and local streets is superimposed, and illustrating inventory as cross-hatched rectangular markers. FIGS. 3A through 3D provide examples of an O-D matrix indexed to the modeled area of FIG. 2. Accordingly, each cell of the matrix contains trip data Nⱼₖ representing numbers of trips from origin TAZ j to destination TAZ k.

The land use file originating in the transportation model includes housing and employment data by model TAZ. These data typically do not carry the level of demographic data required for the reporting component of OMEP. They are supplemented with census information such as gender, age, and educational level attained. The land use data are also extended to include geographic areas not in the model that are required for OMEP. To perform this, an extended TAZ structure is developed based upon the trip counts in a road network within the original transportation model area, the TAZ types and roadway segment types (e.g., interstate, state highway, local road, etc.) in any remaining portion of the area that is represented in the model that is outside of the locally-supplied transit study area. This process serves to project trip behavior onto the extended area in a manner consistent with the original model area.

The OMEP process involves defining TAZ's outside the area covered by the transportation model and estimating trip generations and distributions for such new TAZ's based on similarities to TAZ's within the original model. Because the TAZ structure is extended for OMEP, the O-D matrix also needs to be extended. Extending the O-D matrix is done using a trip generation and distribution process to complete the O-D Matrix. TAZ's that were external to the model are now internal and trips associated with the formerly external TAZ's need to be removed from the model O-D matrix prior to extending the O-D matrix. Finally, new external trips that have a home end in the extended geography are estimated using a similar trip generation and distribution process. External trips with no home end in the extended geography normally are not included in the matrix.

External TAZs in transportation models do not have any defined geography. They represent the universe of area from which non-internal trips have either origins or destinations. This could be 100 feet outside the model area or 100 miles outside. Given this, there is no way of knowing how many of these trips should be removed when the new area is added. To handle this, the method removes all external trips before the new boundary is added. The new internal trips generated by the newly added boundary are then estimated using trip generation and distribution methods. This process is conventional transportation modeling practice.

Only the external trips that have a home within the study area are added. These trips will be added by trip generation and distribution processes of the transportation model so no further algorithm is necessary.

Those trips without a home end in the area are excluded. To include people within the external TAZ's, the same method is used with an average demographic distribution associated with each external TAZ. This allows respondent data to be used in the traffic modeling operations to produce estimates for travel volume in non-traffic model geography.

Traffic Modeling Processes

In a traffic modeling process 120 of FIG. 1, the various files of a transportation model 124 mentioned above are received as inputs. Additional inputs to the traffic modeling process 120 include respondent data 128, traffic data 132, and census data 136. The traffic modeling process 120 employs these inputs to produce trip data for each segment having inventory for various time periods, with additional data associated therewith indicating the home TAZ's for such trips. The various input data and their sources are described hereinbelow.

(1) Respondent Data & its Processing

Respondent data 128 includes data tracking the movements of one or more respondents over a geographic region of interest, such as the extended model area. In certain embodiments, such data is collected by means of portable monitors carried on the persons of the respondents which monitor position with respect to time, changes in position over time or other data enabling tracking of respondents' movements. Appropriate portable monitors for this purpose are disclosed in U.S. patent application Ser. No. 10/640,104 filed Aug. 13, 2003 in the names of Jack K. Zhang, et al., assigned to the assignee of the present application and incorporated herein by reference in its entirety. Location determination techniques include an angle of arrival technique, a time difference of arrival technique, an enhanced signal strength technique, a location fingerprinting technique, and an ultra wideband location technique. Still other useful location determination techniques monitor satellite-based signals, such as GPS signals, in a standard GPS or assisted GPS location determination technique. A still further data collection technique employs such a portable monitor including an inertial monitoring unit that tracks respondent movements.

Respondent re-contacts are also conducted to collect respondent characteristics. These re-contacts, which may be accomplished via telephone interviews and/or mail or email surveys, include questions about individual trips made by the respondent(s) while carrying the portable monitoring units, such as the purpose of the trip(s), the regularity of trip activity, the mode of travel, and who else made the trip(s). This information provides an understanding of trip characteristics, which are used in traffic modeling when assigning vehicle O-D matrices and in setting parameters in trip modeling.

In certain embodiments, the respondent data comprise a series of data structures including respondent path or movement data; road links traveled; trip characteristics; and respondent demographics. This provides multiple records per respondent (one record per respondent and road segment traveled per trip). One file is used for modeling the relationships between trip O-D pairs and the TAZs. This results in a file with one record for each road segment and respondent pair. That means there may be many records in this file for each respondent. The files include respondent identification number, respondent demographic data, a road segment identification number, the time of each trip, the road type, the purpose of the trip, the number of children in a household, the mode of transportation, the frequency and/or how far from home that the trip originated.

The respondent data is processed to produce a set of regression equations to predict the frequency that the respondents traverse road segments in a given period (such as a day or a week). In certain embodiments, Bayesian regression analysis is carried out on the respondent data, using some or all of the following as independent variables: (1) distance from home, (2) the number of persons in the household, (3) the numbers of adults and children in the household, (4) respondent income, race, gender and/or age, (5) day of the week, and (6) road type (country road, city street, limited access highway (including exit or entrance ramp), collector road or distributor road). In certain embodiments, road type is the most heavily weighted variable.

(2) Traffic Data

However, primary respondent data collection, such as the collection of respondent data described above, is a relatively expensive means of gathering data, so that often it is not economically feasible to collect enough data by such means alone to provide an actionable ratings method or system for out-of-home advertising. The traffic data 132 of the embodiments of FIG. 1 normally comprises empirical traffic data in the form of vehicle count data and road networks data and can be acquired from a federal, state or local governmental agency, or else from a commercial source. Such data comprises an interrelationship and mapping of road networks, TAZ's and average daily traffic counts (or volume) over specified road segments within the geographic region of interest.

The vehicle count data are adjusted to a specific period and associated with a road segment in the transportation network. The vehicle count data contain either point information, road name, or mile marker information that are used to geolocate the vehicle count data on to the transportation network. Commercially available data are often pre-geocoded.

Transportation network data contained in the transportation model 124 may or may not be geographically correct. For example, some traffic models use “stick” networks with correct distances shown to simplify the model algorithms. If the transportation network is not geographically correct, in certain embodiments in which inventory locations are geocoded, it will not be possible with such transportation network data alone to accurately determine the relations of the various pieces of inventory to the road segments of the transportation model. Consequently, in such embodiments a geographically correct road network included with the traffic data 132 is selected and conflated with the model road network to extract all necessary model parameters to accurately reflect the geographic locations of the model segments. Conflation is a preliminary, iterative process in traffic modeling used to match model road networks to geographically correct representations thereof contained in the traffic data. The road network may also be extended to a new and larger geographic region of interest using a similar conflation process. The TAZ structure is coded into the new road network so that transportation modeling algorithms can be used.

The source, quality, and coverage of the road networks include city or local streets and collector roads from suburbs up to state, provincial, regional, federal and national highways, and it covers main, secondary, and tertiary arteries. This is analyzed by section (or road segment) with each section representing a stretch of road between significant intersections in order to associate segment attributes therewith, including length, capacity, free-flow speed, travel delay and travel route prohibition information, such as road construction, speed limits and street directedness information (e.g., whether is it a one-way or bidirectional street). Accurate road networks are created from a variety of sources, both electronic and hard copy—for example, electronic road data from government sources and various street directories/maps of city regions.

(3) Census Data

TAZ population levels are obtained from census data for use in estimating and/or adjusting trip generation data both for TAZ's included in the original transportation model, as well as TAZ's in the areas to which the model area has been extended.

(4) Processes

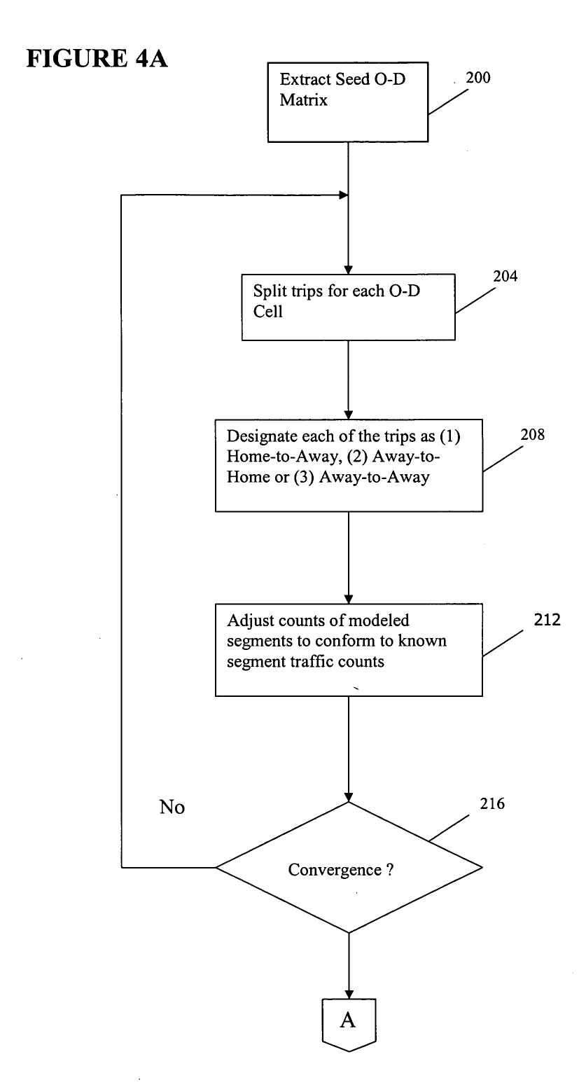

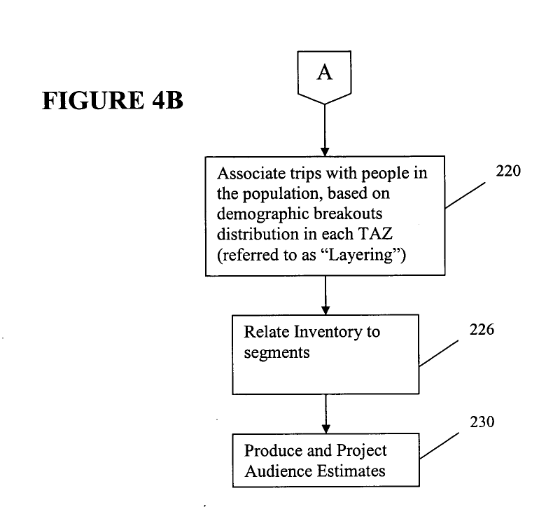

With reference also to FIG. 4A, process 200, to produce trip data by segment, traffic modeling extracts a seed O-D matrix from the transportation model 124. The seed O-D matrix contains a cell for each O-D pair in the transportation model, each cell containing data indicating an estimated number or numbers of trips between the origin and destination represented by the respective O-D pair.

In a process 204, the trips in each cell of the seed O-D matrix are split among paths leading from their respective origin TAZ to destination TAZ in order to estimate vehicle counts for the various segments traversed by such paths. Process 204 is an iterative, bi-level process in which vehicle assignments to paths are made and the O-D matrix is then adjusted to conform to actual traffic count data from traffic data 132.

The vehicles are assigned according to a multi-path stochastic user equilibrium process that converges to an optimal solution where no vehicle can be reassigned from a road segment without increasing the system-wide load. The stochastic component serves to account for sub-optimal behavior in route choices. After each assignment, the O-D matrix is adjusted as explained above and the bi-level process is continued until convergence.

The result of this process is a revised O-D matrix, multi-path information for each O-D pair, and the vehicular volume for each path for each O-D pair. Because the location of each piece of inventory on the road network is known, a vehicle-based estimate of the market is thus enabled. Process 204 is effective due to the accuracy and completeness of the seed O-D matrix taken from the transportation model 124 (including extensions via OMEP). It also uses the traffic count data that is updated regularly to produce a revised estimate.

An exemplary form of the vehicle assignment process is now described. A ‘weight’ or ‘gravity function’ is used to score the ‘cost’ of traveling along a road segment (in distance and/or time and/or monetary cost (e.g., tolls) or more rarely, other characteristics, such as the safety of driving through particular neighborhoods). The weight function may be, for example, (mileage x time). Different possible paths (segment to segment to segment . . . ) that are used by a respondent to travel from a particular origin TAZ to a particular destination TAZ are scored according to the net weight or cost, and the best paths, e.g., those paths having the lowest weight or cost, are selected. For example, the best two paths in one trial may be chosen, but this number is discretionary and may vary from case to case. The trips are split over the set of paths selected, again according to a rule which may vary on a case-to-case basis. For example, with reference to FIG. 3A, if the O-D matrix cell for TAZ H as origin and TAZ F as the destination has three best paths identified with respective relative costs of 40 (5 miles×8 minutes), 60 (12 miles×5 minutes) and 120 (4 miles×30 minutes), the trips can be parsed among the three identified paths at 1/40, 1/60 and 1/120, yielding ratios of 50%, 33%, 16.7%. Thus, one-half of the trips follow the least costly path, one-third follow the fastest (but middle cost) path, and the last one-sixth follow the shortest (but still costliest) path. The parsing rule is not fixed, but may be set according to the importance of these cost factors in each modeled area. Thus, if the O-D matrix of FIG. 3A has 72 vehicle-trips from TAZ H to TAZ F of FIG. 2, 36 trips (72×50%=36) follow the first path, 24 trips (72×33%=24) follow the second path and the final 12 trips (72×16.7%=12) follow the third path. The cell representing trips from TAZ H to another TAZ, for example, TAZ A, will have different vehicle-trip paths, and weights.

This is repeated for every O-D cell (that is, for each possible origin TAZ and destination TAZ pairing represented by the matrix). Now, for example, paths are established for all trips from TAZ H to every other TAZ, plus all trips from each and every other TAZ that go to TAZ H.

In a process 208 of FIG. 4A, each of the trips in the O-D matrix is determined to be either (1) a home-to-away trip (a trip originating in a home TAZ), (2) an away-to-home trip (a trip whose destination is a home TAZ) or (3) an away-to-away trip (one for which home is neither the origin nor the destination). From the TAZ descriptive information (census, household characteristics, land usage, etc.) as well as the regression equations obtained using the respondent data, the number of round trips expected from each TAZ are projected to reflect the demographics of its population, which in one combination or another are manifested through the O-D trips. For example, it may be projected that 600 round trips are generated by TAZ F of FIG. 2A. Assume that TAZ F is part of 1464 total trips (1464 in some trip O-D pair as the origin, and 1464 where the O-D pair is the destination). This means that 600 of the trips with TAZ F as the origin are home-to-away trips (they are the start of a ‘round-trip’), and 600 of the trips with TAZ F as the destination are away-to-home trips (the ends of complete round-trips). This leaves 864 O-D trips with TAZ F as the origin, and 864 with TAZ F as the destination, which are due to away-to-away trips (somewhere in the middle of a ‘round-trip’). It needs to be calculated, for each O-D (TAZ-to-TAZ) cell, how many trips are home-to-away, away-to-home, and away-to-away. That is the purpose of the three additional matrices of FIGS. 3B, 3C and 3D. Entire ‘round-trips’ in all combinations need to be approximated to ultimately estimate the number of individual persons reached. For example, knowing that there are 1000 billboard exposures along a path from TAZ F to TAZ H and 1100 on a path from TAZ H to TAZ F, it is desirable to know how many of the exposures were to the same people (some people have a round trip from TAZ F to TAZ H, some have round-trip from TAZ H to TAZ F, some have only one leg but didn't return along the reverse path, etc.).

Away-to-away trips are assigned to the away-to-away O-D matrix. In the example, TAZ F is the end of 864 trip segments (and is the beginning of 864 other trip segments) that are away-to-away. For the 72 trips from TAZ F to TAZ H in the example, however many are home-to-away (TAZ F is home; TAZ F to TAZ H is thus the beginning of the total round-trip), away-to-home (TAZ H is home; so TAZ F to TAZ H is the final leg of the total round-trip), or away-to-away (the TAZ F to TAZ H trip is neither the first nor last leg of the round-trip; the home is in some other TAZ entirely) are modeled.

The starting assignments of O-D trips into the home-to-away, away-to-home, and the away-to-away matrices may be initialized any number of ways in a standard four-step transportation model. The set of matrices are adjusted in such fashion that each modification results in a net lower total system ‘cost’ against a selected standard. Continuing the example, assume trip types are initially assigned from TAZ F to TAZ H as being in some joint proportion. In the example, 600÷1464 (41% of the time), TAZ F is the home origin of the total round-trip, 864 are not (59% of the time). TAZ H may be a home end of the round-trip 43% of the time, and is not the other 57%. So, the difference may be split and TAZ F initialized to having 41% of its trip segments (when it is the origin of the O-D pair) as home-to-away, and 59% are not. Of that 59%, 43% may be where TAZ H is the home end, thus TAZ F to TAZ H is initialized to 41% home-to-away, 43% away-to-home, and leaving 16% to be away-to-away. This is repeated for all O-D matrix cells. Next, ‘swapping’ types between O-D pairs is done. In a conventional four-step transportation model, trips are adjusted until the total system ‘cost’ can not be reduced any further. Thus, assuming a simplified cost or gravity function calculated as the product of the average net trip distance and the average net trip time, a condition may arise in the example like this: Assume trips into TAZ F (O-D pairs with TAZ F as destination) average 6 miles and 15 minutes, trips from TAZ F to TAZ H (O-D pairs TAZ F-TAZ H) average 5 miles and 10 minutes, and finally, trips out of TAZ H (O-D pairs with TAZ H as origin) average 10 miles and 20 minutes. Using averages of averages, we see TAZ F to TAZ H away-to-away trips ‘average’ 6+5+10=21 miles as the sum of the average trip coming into TAZ F, plus average for a trip from TAZ F to TAZ H, plus average trip continuing onward from TAZ H. Similarly, 15+10+20=45 minutes is the ‘average’ three-piece trip time. The (distance×time) cost function scores this as 21×45=945. Assume that if this same exercise is performed for O-D pair TAZ S to TAZ T, the cost is only 800. Then, we can ‘swap’ a home-to-away designation to become an away-to-away designation for a TAZ S to TAZ T trip, and correspondingly change an away-to-away trip designation to home-to-away for O-D pair TAZ F to TAZ H. This choice conforms to the condition that the total system ‘cost’ over all O-D pairs is reduced. This process is continued until cost can no longer be reduced.

While the system is optimally efficient against this gravity function or cost score, TAZ-level home-to-away vs. away-to-home vs. away-to-away proportions may be inappropriate based on previously assigned proportions. These are re-apportioned (but now TAZ F may have more home-to-away going to TAZ H than before, and fewer to one or more other TAZS). This process is repeated until acceptable convergence occurs.

In certain embodiments O-D trip assignments are made separately for each demographic group based upon cost functions that are most appropriate for each group. Accordingly, separate trip assignment tables or other data structures are produced for each demographic group in such embodiments.

Calibration Process

A calibration process 212 is carried out. “Calibration” refers to ensuring that where there are empirical traffic counts, the data in the O-D matrix match those numbers. Where there are no empirical traffic count data, relationships (or ratios) between the empirical data and traffic modeled data are utilized to adjust the modeled data. Calibration 212 ensures a higher level of validation than the use of traffic modeling 120 alone.

While government traffic counts are among the inputs into traffic modeling 120, traffic modeling by its nature is less precise and more future-oriented than that which is required for an outdoor ratings service. When performed correctly, calibration ensures that traffic count estimates are matched to known traffic counts.

Calibration 108 receives the O-D matrix from process 208 as well as data from large-scale travel surveys, usually provided by government sources. Calibration is performed using outlier analysis, marginal weighting and multilevel weighting processes described hereinbelow. Where actual traffic counts are known, these numbers are substituted for the modeled data in the O-D matrix.

(1) Outlier Analysis

Statisticians have devised several ways to detect outliers. Outliers are atypical or infrequent observations in a set of data. In outlier analysis according to certain embodiments of the present invention, how far an outlier is from the mass of data is quantified. The ratio Z is calculated as the difference between the value of an outlier, β, and the adjusted mean, μ, divided by the standard deviation, σ, of the set of data, i.e., Z=(β−μ)÷σ. If Z is large, the value of the outlier is far from the other data. Note that the adjusted mean, μ, and standard deviation, σ, are calculated from values that exclude or minimize the potential influence of outliers.

One property of a Normal (Gaussian) Distribution is that, if a standard deviation is calculated and multiplied by 1.96, the lowest 5% and highest 5% of the sample values will on average fall outside of the range defined by the sample average minus that amount extending to the sample average plus that amount (the remaining 90% will on average fall within this range). That is, if one has a large sample of Gaussian-distributed values, and the average is 200, and the standard deviation is 10, then 1.96×10=19.6, so in general, we expect that 90% of the sample values will fall within 200±19.6 (all but the lowest 5% and highest 5% of the sample values fall within the range 180.4 and 219.6). We call these lowest and highest values ‘outliers’. Outliers may be estimated from distributions of market data by such subdivisions as road type, e.g., city street vs. interstate highway, or by county.

Once an outlier has been identified, that value may be excluded from the analyses or kept. Keeping the outlier means that, although the value is outside the expected data range, it is still considered accurate data because the outlier includes values known to be valid. For example, this happens when state traffic counts are found among the outliers. This has happened in some data analyses when traffic counts are examined at the road type level—for example, in city street or state highway distributions.

(2) Marginal Weighting

Marginal weighting conforms estimates of traffic counts by road segment to reference data values. This involves using empirical traffic counts as target marginal values and the road segment estimates from traffic modeling as O-D matrix cell counts (or frequencies, e.g., trips per day or trips per week). Separate iterations of separate matrices are run to account for additional system variables, such as time of day (peak and off peak travel) or trip purpose. An additional step is performed if any road segment has no projected traffic: by comparing similar road types as well as the regression equations obtained using the respondent data, the occasional ‘zero’ projected traffic count is reinitialized (‘imputed’) to some representative value, since the marginal weighting algorithm itself cannot adjust zero values to non-zero values. Marginal weighting provides road segment counts for TAZs on the fringe of the traffic-modeled area, that is, outside of the borders of the area that is explicitly traffic modeled.

(3) Multilevel Weighting

In the multilevel weighting phase of calibration, traffic counts are validated against an external standard or source. Experience with traffic modeling alone suggests that traffic modeling produces many estimates of traffic counts different from government traffic counts and that most of those differences range from a few percentage points up to 50%. This is unacceptable for an outdoor advertising ratings method. However, by taking the extra step of calibration after traffic modeling, traffic counts are matched where they exist and calibrated for road segment estimates for those inventory locations where no reference data is available.

Road segments which do not have corresponding empirical traffic counts are ‘conformed’ by the multilevel weighting process. This means that the modeled traffic counts for given segments are adjusted to be in the same relative proportion to other roadway traffic counts of the corresponding roadway type as occurs between roadway types where explicit external traffic counts are supplied. Thus, if external interstate traffic counts run 50% higher than external counts for state highways, the modeled traffic counts for interstate road segments without externally-supplied traffic counts will run 50% higher than the modeled traffic counts for state road segments without externally-supplied traffic counts.

Demographic Layering

The foregoing processes do not provide traffic data for specific individuals within the demographic groups to be reported by means of the disclosed embodiments of the invention. In a demographic layering process 220 of FIG. 4B and FIG. 1, demographic categories are layered on as an add-on to the traffic modeling process, using household size, car ownership, employment status, age and gender groupings data. The level of those demographics is reasonably detailed, with travel behavior for each group amenable to further refinements (i.e., occupational breaks). The census data is applied to the traffic model to produce demographic breakdowns for travel behavior as represented by the traffic model.

Layering the demographics involves associating the home end demographics with the number of vehicle-trips that traverse each road segment with inventory. The method starts by associating a home TAZ with each trip in the non-home-based vehicle matrix, where the vehicle occupancy rate used is the regional average, where available. Otherwise, a default of 1.25 persons per vehicle is used. This association is done using the other two matrices where a home end is known. For each O-D pair in the non-home based matrix where the origin is TAZ A and the destination is TAZ B, the percent distribution of all home end TAZs is calculated from the other two matrices where the non-home end is either TAZ A or TAZ B. Home and non-home based vehicle matrices are combined or associated proportionately to arrive at the proportion of trips that are not home based. That is, if 80% of the trips are home based, then 20% of the trips are not home based, and constitute the non-home based (end or start) O-D matrix. Given this process, the home end of each O-D pair in the non-home vehicle trip matrix is known.

The path for each O-D pair is traversed and the number of vehicles and their home TAZ recorded on each road segment. Once complete, a database lookup is performed for each link and a list of the total vehicle (person) trips by home TAZ is generated by using the road segment. From the home TAZ, the demographic distribution used to produce inventory exposure estimates is extracted.

As noted above, in certain embodiments separate data structures are produced for each demographic group containing path data based on separately selected cost functions for each group. In such embodiments, layering is performed for each group based on its respective path data.

A problem arises when vehicles or people make a trip, for example, from work to shopping (a non-home based trip) and their home TAZ is not known. This is needed for associating their demographics. To address this, the method creates the post-trip chaining process using the other two trip matrices. A trip chain can be a trip from home-to-work, work-to-store, then store-to-home. These are the elements of a chain. In chaining, the objective is to use the home-start and home-end trips to define missing trips in the chain—in this case the one from work-to-store.

Because some trips starting at home are going to the store, both trip sets are used in conjunction with the store-to-home set. Unbalanced trips may occur, where there are more or fewer home trips originating, for example, from TAZ Q to TAZ A than there are return trips from TAZ A to some other TAZ to TAZ Q plus the TAZ A to TAZ Q directly (i.e., more or fewer trips wind their way home to TAZ Q from TAZ A than went to TAZ A from TAZ Q).

To recreate the chaining, the method uses all trips using the store with a home end. There will not be a balance between trips leaving home and those returning home. Part of this is so because a 24-hour period does not necessarily balance out. Balance is accomplished within this post-trip chaining process. This is done by ensuring that the number of trips home based and other trips add to the total of all trips. Because the method actually has several of a person's vehicle trips in the model, the non-home based trip is linked to home based trips that included one of the two ends the vehicle or person used. A probabilistic assignment of the trip is made to one of the trips that do have a home end. This balances trips to home and back.

The method randomly (or at least pseudorandomly) selects from the possible chains. Herein it will be understood that the term random will also include the term pseudorandom. The randomization is weighted to account for distance or the number of homes at the TAZ. The randomization is also weighted to account for balancing as mentioned above. In effect, weighting is adjusted after each randomization.

From this, the method is able to assign a home TAZ to a person's trip. The person's vehicle trip is left intact so that he/she continues to travel between the same two TAZ's, but the trip is associated to a third TAZ for its home information.

Outdoor Inventory

With reference to 226 in FIGS. 1 and 4B, outdoor inventory data is supplied so that inventory can be associated with the segments for producing its respective audience estimates. For this purpose, outdoor Inventory data includes, for example, a listing of the inventory location (latitude and longitude), inventory owner, whether or not the inventory is audited by a trade group or whether the information is supplied by the inventory owner, and if audited by a trade group, the designated daily circulation number and audit road segment. Also included is an owner assigned inventory number, the location description (for example; Bankhead Hwy 800 FT W/O Cooper Lake Rd SS). Also included are road segment indicators, the direction in which the media faces, how many hours a day the inventory is visible (12, 18, 24), the county, zip code and inventory type.

The accuracy of inventory data is ensured by examining the source, quality, and coverage of the inventory data. The inventory in a market includes all locations, illuminations, directionality, etc. The accuracy of this data helps in producing actionable outdoor ratings. Such information is acquired for each site in a market. This undergoes regular updating to ensure valid associations between road segment audiences and outdoor inventory.

The outdoor inventory data 226 including the information noted above is associated with audience estimates through linkage by road segment number. The longitude and latitude of inventory locations and road segment networks are used with location coordinates to match inventory to its respective physical locations. This is facilitated by the use of mapping software, which provides visual representations of the association between the outdoor inventory and the road segments they face. This is performed for each inventory site in a market and is updated from time to time to ensure valid associations between road segment audiences and new outdoor inventory.

In the United States the Traffic Audit Bureau (TAB) audits specific outdoor operator inventory information. Each outdoor operator has records of their individual inventory, some of which is audited by the TAB. These inventory records are merged with TAB data and unduplicated for use in estimating outdoor ratings.

As noted above the outdoor inventory is related to the road network so that identification can be made to every road segment from which inventory can be viewed. This process uses a geographic automation lookup with an accuracy tolerance. The inventory contains latitude and longitude (point) data that are placed on the road network and associated with a road segment using a weighted scheme of distance and size of road. Where the algorithm does not identify a viable road the inventory is flagged. Inventory that may be viewable from more than one road is also flagged when two or more roads are all within a reasonable tolerance. The automated process identifies the direction from which the inventory can be seen because the inventory data contains compass demarcations for viewing. Once the automated task is complete, a manual validation effort is performed. During this step, flagged inventory is handled.

The object of the weighting process is to choose the road that is likely to be the focus of a billboard or other inventory. There may be a close road with very low vehicular traffic volume and a road slightly farther away with a much greater traffic volume. The weighting scheme accounts for distance and volume in selecting the higher traffic volume road. A distance cutoff threshold is established so that an extremely high volume road miles away is not chosen.

Inventory is not limited to a single roadway mapping. It can accrue trip impressions from multiple segments. A weighting scheme is employed to select the most significant (primary) target road and then possible (secondary) roads from which the inventory may also be visible. A manual exercise confirms that these secondary roads are appropriate. For each inventory, the method keeps a list of road segments from which the inventory can be seen and accrues estimates on this basis. Given the route knowledge, the method can identify those vehicles that traverse both roads and not count them again.

Production of Audience Measurement Data

When the foregoing processes have been completed, audience estimate data is produced in a process 230 in FIGS. 1 and 4B. Based on the O-D matrices and path data produced as explained above, a data structure is produced listing the O-D pairs and paths. Estimates of total reach for each outdoor inventory location are obtained by traversing the paths to identify the segments used and inventory visible therefrom in the direction of travel for each trip. Thus, if a trip from TAZ A to TAZ B proceeds along Rt. I-95 from exit 45 to Exit 61, inventory, visible to the traffic along Rt. I-95 between those exits and traveling in that direction, is identified in estimating reach for such trip. For each path for each O-D pair passing through a segment with outdoor inventory, reach and impressions by demographics are produced and accumulated for each piece of inventory.

For each path, the process determines the number of vehicles, and therefore people, making a Production-to-Attraction (P-A) trip, such as home to work, and the number of vehicles or people making an Attraction-to-Production (A-P) trip, such as shopping to work. Persons making P-A trips have demographics of the trip origin, while persons making A-P trips have demographics of the trip destination.

For each segment in the path, an expected frequency is produced based upon the regression equations produced with the use of the respondent data. Other variables used in the calculation of expected frequency are street direction (one-way, two-way) and posted speed limits. This is done for both congested and uncongested traffic. The data obtained from the paths is later combined to provide a total. In certain embodiments, the total =[0.35×(congested path results)+0.65×(uncongested path results)]. Thus, in these embodiments it is estimated that 35% of the trips along this path occur during congested traffic periods (e.g., ‘rush hour’), and the remaining 65% are estimated to occur at other times when traffic is uncongested.

Reach for a given segment is produced as the number of persons in vehicles making a trip (gross impressions) divided by the expected frequency and is added to the running total for reach for that segment. The process converts census information for each TAZ into demographics for each segment that has inventory. Origin and destination TAZ demographics determine how reach estimates for each link path are allocated to an outdoor inventory location.

Exposure (or Gross Impressions) is the volume of trips over a road segment—normally expressed as the number of persons in a vehicle (regional average where available or a default of 1.25 persons per vehicle in certain embodiments), but weighted across each demographic category based upon the average number of trips per day for each demographic group. For example, if 12% of the persons in a TAZ are males aged 18-24, then that demographic group represents 12% of persons, but if they travel often, they may represent 20% of trips per day. These weights represent trips per day (or week) per demographic group. This weighted exposure is used to produce the running total for reach for each road segment having outdoor inventory. When all of the paths have been traversed, the method produces overall frequency as: (Frequency=Weighted Gross Impressions÷Total Reach) for each road segment, whether or not it has outdoor inventory (e.g., to produce potential audience measurement estimates, such as for purposes of providing future advertising on such road segment(s)). The result is audience estimates for each road segment (with or without inventory) calculated and written to an audience database containing: Reach, Frequency, GRPs, and Gross Impressions for the reporting period, both as persons and percent of population, broken into demographics for each gender and the combined population.

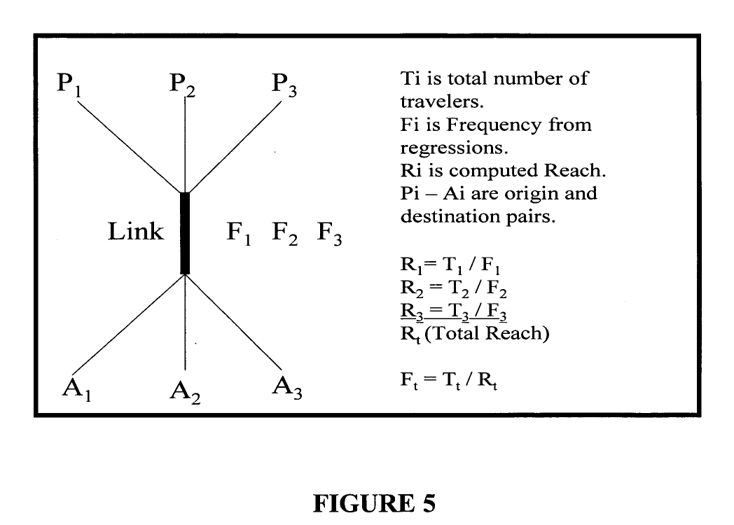

An example of the above process is explained in connection with FIG. 5 for a total persons computation on one road segment (assuming a one-way link and ignoring congestion for purposes of simplicity and clarity). This inventory location has traffic passing thereby from three origins to three destinations, with only three pairs. (This is a simplified example because three origins and three destinations would normally generate 9 paths through the link.

To get the unduplicated traffic for the inventory location, regression computations estimate the average frequency (F) of travel for each of the three origin (P) and destinatiori (A) pairs. In unduplicated traffic the same ‘person’ counts as one for a ‘traffic’ or ‘cumulative’ or ‘reach’ estimate, even for those that pass the particular piece of inventory multiple times (i.e., with multiple ‘exposures’ or ‘impressions’).

Each P-A pair in FIG. 5 has its frequency estimate, Fᵢ, (from regression analysis), divided into the total number of travelers, Tᵢ, for the Pᵢ-Aᵢ pair to give the reach, Rᵢ, for the Pᵢ-Aᵢ pair:
(P-A)₁: R₁=T₁÷F₁ (1a)
(P-A)₂: R₂=T₂÷F₂ (1b)
(P-A)₃: R₃=T₃÷F₃ (1c)

For example, if P₁-A₁ has a traffic count of 24,300 persons per week and a modeled trip frequency of 7.5 trips per person per week, then 24,300 trips divided by the regression modeled 7.5 trips per person per week equals an estimated reach of 3240 people. Frequency for the location, F_{Loc}, is the weighted gross impressions divided by the total reach (R₁+R₂+R₃):
F_{Loc}=(Weighted Gross Impressions)u÷(R₁+R₂+R₃) (2)

Accordingly, in certain embodiments average frequency for the location is produced based on an accumulation of estimated reach numbers for each path which, in turn, are estimated from separate path frequencies produced from regression based on the respondent data.

Projection of Estimates Beyond Survey Period

In process 230 the audience estimates are projected to time periods beyond the survey period based on the respondent data by fitting a growth curve to such data. In certain embodiments, a negative binomial model is used for this purpose. Two approaches are disclosed hereinbelow using the negative binomial model.

Approach 1: Reach is modeled according to Negative Binomial function

A random variable, Iₘ, representative of reaching a person for the first time on the ‘m^{th,}’ day is modeled by a Negative Binomial Distribution, NB(a, p), and is denoted by: Iₘ˜NB(a, p). Representative parameters “a”, which dictates the ‘shape’ of the distribution curve, and “p”, which is a measure of the ‘scale’ of the probabilities involved, are estimated from the set of previously produced respondent reach rates for a time period being projected. The parameters of a negative binomial can also be interpreted as identifying a gamma distribution fit to Poisson exposure rates to account for the actual respondent reach data collected in the outdoor sample. In various embodiments, the random variable Iₘ is modeled from families of distributions, such as the Binomial family, a hypergeometric family or by linear regression or generalized curve fitting.

The estimated probability, P(n), that a person is initially exposed to inventory for the first time on the ‘n^{th,}’ opportunity is computed from the equation:

$$P ( n ) = ( \begin{matrix}a + n - 2 \\ a - 1\end{matrix} ) {{p}^{a} ( 1 - p )}^{n - 1} \qquad ( 3 )$$

Thus, for example, for a time period of 3 days, assuming in this example that there is one opportunity per day, and 3 opportunities, the reach for a population of 1200 persons during this time period, with distribution ‘shape’ parameter “a”=2, and probability ‘scale’ parameter “p”=¼=0.25, would be obtained by adding up the proportions of people initially exposed to inventory on the first opportunity (day) (n=1), plus those initially exposed to inventory on the second opportunity (n=2), plus those people initially exposed to inventory on the third opportunity (n=3):

$$\begin{matrix}\begin{matrix}P ( n = 1 ) = ( \begin{matrix}1 + 2 - 2 \\ 2 - 1\end{matrix} ) {.25}^{2} {( 1 - .25 = .75 )}^{1 - 1} \\ = 1 \times .0625 \times 1 \\ = .0625\end{matrix} & ( 4 ) \\ \begin{matrix}P ( n = 2 ) = ( \begin{matrix}2 + 2 - 2 \\ 2 - 1\end{matrix} ) {.25}^{2} {( 1 - .25 = .75 )}^{2 - 1} \\ = 2 \times .0625 \times .75 \\ = .046875\end{matrix} & ( 5 ) \\ \begin{matrix}P ( n = 3 ) = ( \begin{matrix}3 + 2 - 2 \\ 2 - 1\end{matrix} ) {.25}^{2} {( 1 - .25 = .75 )}^{3 - 1} \\ = 6 \times .0625 \times .5625 \\ = .03515625\end{matrix} & ( 6 )\end{matrix}$$

Since 0.0625+0.046875+0.03515625=0.14453125, just under 14.5% of the targeted populace were initially exposed to inventory in three opportunities. In this example the probabilities are summed and the result multiplied by the population to obtain the total persons initially exposed to inventory during the target time period.

The parameters “a” and “p” are estimated by using the actual reach values from sample collected for two different time periods, such as three-day exposure information and one-week exposure information derived from the respondents (e.g., from a travel log or data gathered using a portable monitor). Solving for the two variables from these two data sets yields a unique ‘a’ and ‘p’ parameter pair.

Approach 2—Frequency is modeled according to a Negative Binomial function, and Reach is derived from exposures and frequency.

A random variable, Tₘ, representative of having a person exposed to inventory ‘m’ times in a specified time period is also modeled as following a Negative Binomial Distribution and is denoted by: Tₘ˜NB(a, p), where representative parameters “a” and “p” are estimated from the set of actual respondent reach rates for the time frame being projected. These parameters identify a best gamma distribution fit of Poisson exposure rates to account for the actual respondent reach data collected in the outdoor sample. The actual values of the shape parameter “a” and probability ‘scale’ parameter “p” will be different for the frequency model than for the reach model above.

The estimated probability, P(m), that a person is exposed to inventory ‘m’ times in a time period being considered is computed from the equation:

$$P ( m ) = ( \begin{matrix}a + m - 1 \\ a - 1\end{matrix} ) {{p}^{a} ( 1 - p )}^{m} \qquad ( 7 )$$

Thus, consider the persons exposed to inventory m times in a week out of a population of 2000, with shape parameter “a”=2, and probability scale parameter “p”=95%=0.95 for a one week period. This can be obtained by subtracting the proportion of people who were exposed to inventory zero times in a week (‘m’=0 in Eq. 7) from the total population; everyone else is exposed to inventory one or more times in the week. Thus,
P(m=0)=0.95²=0.9025 (8)

Thus, 1−0.9025=0.0975 is the proportion of the 2000 people exposed to inventory at least once in the time period being considered, such as a reporting period. 9.75% of 2000 is 195 persons. As for the reach model, the frequency model negative binomial parameters “a” and “p” are estimated from two actual sample time periods, such as three-day exposure information and one-week exposure information derived from the travel sample respondents. From audience modeling, detailed advertising campaign delivery results are generated based on schedules of locations selected for desired reporting periods. Audience numbers are based upon the selected inventory location's viewing and illumination period, and advertising campaigns with an equal number of sites will not automatically achieve the same result.

Projection of Estimates using the Model

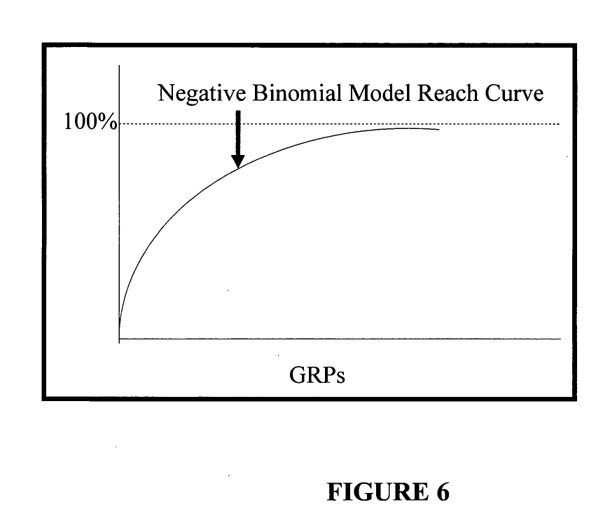

The Negative Binomial Model uses the estimates produced for the survey period (the period over which data is collected) and projects them out to the reporting period (the period through which the model projects). This reach curve of the Negative Binomial Model is of the general form seen in FIG. 6.

During the process of computing travel routes (based upon trip O-D TAZs) from respondent movement data, the process assigns demographics to those paths by applying respondent data to road segments. Frequency is estimated as demographically weighted gross impressions divided by reach for each surveyed road segment with inventory. Rating values are expressed in percentages of the population for specific demographic categories for each road segment with inventory (creating GRPs), followed by data integration and projections of those frequency estimates to all outdoor inventory locations.

The method applies the Negative Binomial (Gamma-Poisson) Model to those estimates of reach and frequency for a desired reporting period. Audience modeling involves focusing on the Poisson exposure distribution for any one individual and the Gamma distribution of individual Poisson rates across the population. The model has two parameters: Mean exposure rate in the population, μ, which comes from the respondent movement data, and the variance, σ², of individual exposure rates about the mean, which comes from the variance of those rates.

The basic unit of analysis is road segments per day, coupled with generic descriptors for those units such as residential area, downtown, shopping area, major highway; weekday, weekend day, etc., sorted by traveler demographics and trip purpose characteristics. The Negative Binomial Model produces reach and exposure frequency numbers for each demographic group and works for any combination of road segments and any number of days.

During the process of computing travel routes (based on trip O-D TAZs) from respondent movement data, the method assigns demographics to those paths by applying respondent data to road segments having outdoor media. Exposure frequency is estimated as demographically weighted gross impressions divided by reach for each surveyed road segment with inventory. Rating values are expressed in percentages of the population for specific demographic categories for each road segment with inventory, followed by data integration and projections of those estimates to all market area outdoor inventory locations.

Data Integration

Data integration ties together the various data sources described above to form a complete picture of market outdoor inventory ratings. Both primary and secondary data are included.

The method of the invention uses multiple data sources to produce ratings data integration keys that enable the system to associate the data from the various sources and overlays that combine both primary and secondary source data. For example, primary data collection, census demographics, traffic counts converted to persons in cars (post-calibration), and inventory locations and road segments share a common linkage at the TAZ level.

This involves a two-stage methodology. Various data sources are integrated based on forming respondent level data segments in each database. Integration includes matching groups of respondents in each data source using common geodemographic and other characteristics to associate those attributes with travel behavior.

Respondent groups are paired with census groups. Respondents (with common demographics) who indicate they use the same combinations of road segments and share other trip characteristics form segments that bridge between the two data sources.

Relationships are generalized in data sources by going beyond the simple groupings of respondents into like clusters. Multiple dimensions of respondent characteristics, media behavior, and (potentially) product and service usage are employed to create a projection of the interrelationships between media and buyer behavior. As will be seen from the foregoing disclosure this involves a multivariate model driven by interrelationships between and among all of these variables to project inventory exposures from demographics and other characteristics.

The benefit that accrues from imputation is that there are no “zero cells” or small sample counts because the interrelationships in the data are used in producing linkages within the data, and in reporting. The interrelationships are between demographic or geographic characteristics and inventory exposures. This also involves the use of a finite mixture model of multidimensional multivariate distributions. The “finite mixture” is to handle multiple regions with distinct multidimensional multivariate distributions. “Multidimensional” refers to a spanning set of underlying distribution types embedded in the methodology (e.g., Pareto, logistic, Burr, and other distributions). “Multivariate” refers to the ability to distinguish behavior patterns of numerous respondents.

Reporting

In a process 240 of FIG. 1, the estimates from the outdoor inventory ratings method are represented to users interactively with inventory and audience descriptions and mapping functions showing the location of inventory in a market.

Outdoor inventory audience numbers, including gross impressions, reach, and frequency, are shown by outdoor inventory location. By inventory site demographics are detailed along with inventory characteristics such as location, type, direction, and illumination.

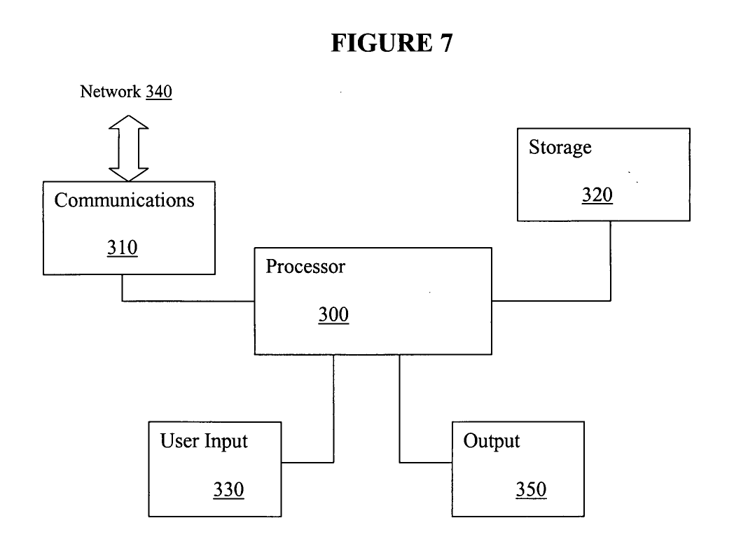

A system in accordance with certain embodiments of the present invention is illustrated in block form in FIG. 7. A processor 300 is coupled with storage 320 to access programming containing instructions for carrying out the processes described hereinabove. The processor 300 is also coupled with communications 310 for communication with a network 340 and is coupled with a user input 330 to receive user commands and/or data. The various data sources including the transportation model, census data, respondent data, traffic data and outdoor inventory data are accessed by or supplied to the processor 300 by means of the user input 330, storage 320 and/or the network 340 via the communications 310. Data output, such as reports of estimates, are supplied via communications 310 to the network 340 or by means of an output 350.

Methods and systems have been disclosed that employ primary data collection at a respondent level in model-based outdoor advertising audience estimation to afford reach and frequency estimates not otherwise available from preexisting services. Consequently, the vast preponderance of inventory is reportable with non-zero audience estimates at the demographic cell level and the problems of duplication of exposure, inherent in traffic flow models, is overcome.

At the same time, the implementation of such model-based methods and systems provides the ability to generate data at a discrete level for such a vast preponderance of inventory units. Yet such methods and system are economically viable since they enable the use of relatively small panels of respondents and thus require the acquisition and deployment of relatively small numbers of costly portable monitors to equip such respondents. Such methods and systems are also readily scalable for smaller markets where a service relying solely on primary data would be too costly to implement.

The disclosed methods and systems, by providing outdoor inventory audience estimates including reach, frequency and exposure with demographic breakdowns, provides the building blocks for creating media plans by combining locations and days against target audience demographics, and provides a realistic means for comparing the effectiveness and cost of outdoor advertising with other forms of advertising media, such as broadcast and print media.

Although various embodiments of the present invention have been described with reference to a particular arrangement of parts, features and the like, these are not intended to exhaust all possible arrangements or features, and indeed many other embodiments, modifications and variations will be ascertainable to those of skill in the art.

What is claimed is:

1. A method for estimating exposure to outdoor advertising, comprising:
receiving respondent data representing movements of participants in a study;
receiving traffic data representing actual or predicted movement patterns of traffic within a geographic region; and
producing exposure data representing estimations of exposures to outdoor advertising based on the respondent data and the traffic data.

2. The method of claim 1, comprising producing exposure data representing estimations of exposures of a population within the geographic region to the advertising based on the respondent data and the traffic data.

3. The method of claim 1, comprising receiving respondent data including demographic data pertaining to demographics of the participants; and producing exposure data representing estimations of exposures to advertising broken down by demographic groups.

4. The method of claim 1, comprising receiving empirical traffic data and modeled traffic data and comparing the empirical traffic data and the modeled traffic data to produce compared traffic data; and producing exposure data utilizing the compared traffic data to produce the exposure data.

5. The method of claim 1, comprising producing exposure data representing estimations of exposures to advertising for selected time periods.

6. The method of claim 1, comprising extending the geographic region represented by the traffic data to provide an extended geographic region, and producing exposure data representing estimations of exposures to advertising within the extended geographic region based on the respondent data and the traffic data.

7. The method of claim 6, wherein the traffic data comprises data from a transportation model corresponding to the geographic region.

8. The method of claim 6, comprising extending the geographic region based on trip counts within the geographic region, predefined transportation analysis zones of the geographic region and roadway segment types outside the geographic region.

9. The method of claim 6, comprising projecting trip behavior represented within the traffic data to a geographic region extending beyond the geographic region represented by the traffic data.

10. The method of claim 6, wherein the respondent data represents movements of participants within the extended geographic region.

11. The method of claim 1, comprising extracting origin-destination data representing origins and destinations of trips from the traffic data for use in producing the exposure data.

12. The method of claim 11, comprising excluding origin-destination data representing trips in which neither the origin nor the destination represents a home within an area of study represented by the exposure data.

13. The method of claim 1, wherein the respondent data is received utilizing portable monitors carried by the participants, the portable monitor adapted to track movement of the participants.

14. The method of claim 1, comprising receiving respondent data representing road links traveled by the participants; and producing records for each respondent identifying origins and destinations of trips by the respective respondent.

15. The method of claim 14, comprising dividing the geographic region into a plurality of transportation analysis zones; and modeling relationships between the origins and destinations identified in the records and the transportation analysis zones.

16. The method of claim 14, comprising predicting frequencies that the respondents traverse selected road segments in a given period of time based on the respondent data and the produced records.

17. The method of claim 14, comprising predicting frequencies that the respondents traverse selected road segments in a given period of time based on a distance of the respective road segment to a home of the respective respondent.

18. The method of claim 14, comprising predicting frequencies that the respondents traverse selected road segments in a given period of time based on at least one of a number of persons in a household of the respective respondent, and a number of adults and children in a household of the respective respondent.

19. The method of claim 14, comprising predicting frequencies that the respondents traverse selected road segments in a given period of time based on at least one of an income of the respective respondent, a gender of the respective respondent, and an age of the respective respondent.

20. The method of claim 14, comprising predicting frequencies that the respondents traverse selected road segments in a given period of time based on at least one of a day of the week and a type of the respective road segment.

21. The method of claim 1, wherein the traffic data represents movement patterns of traffic over road segments represented in a geographically incorrect manner.

22. The method of claim 21, comprising ascertaining relationships between the road segments represented by the traffic data and each of a plurality of advertisements disposed at respective locations viewable from at least one road segment within the geographic area.

23. The method of claim 21, comprising ascertaining from the traffic data movement patterns of traffic over geographically correct road segments.

24. The method of claim 1, comprising receiving vehicle count data representing actual volume of traffic over specified road segments; and producing exposure data representing estimations of exposures to advertising based on the respondent data, the traffic data and the vehicle count data.

25. The method of claim 1, comprising receiving census data representing information about a population within the geographic region; and producing exposure data representing estimations of exposures to advertising by the population using the census data.

26. The method of claim 25, comprising using data from a land use file of a transportation model to produce the exposure data.

27. The method of claim 26, wherein the land use file arranges land use data by transportation analysis zone, and the census data supplements the data of the land use file.

28. The method of claim 1, comprising ascertaining from the traffic data origin-destination data representing origins and destinations of trips of a population represented by the traffic data; and producing exposure data based on the trip data and known locations of the outdoor advertising.

29. The method of claim 28, comprising receiving vehicle count data representing actual volume of traffic over specified road segments; and revising the exposure data based on the vehicle count data.

30. The method of claim 29, comprising periodically receiving updated vehicle count data and revising the exposure data based on the updated vehicle count data.

31. The method of claim 28, comprising adjusting the origin-destination data in accordance with a weight function based on a cost of traveling to produce adjusted origin-destination data.

32. The method of claim 31, wherein the weight function corresponds to at least one of a distance of the respective trip, a monetary cost of the respective trip; and a time of the respective trip.

33. The method of claim 31, wherein the weight function corresponds to at least two of a distance of the respective trip, a monetary cost of the respective trip, and a time of the respective trip.

34. The method of claim 28, comprising adjusting the origin-destination data in accordance with a reduction in a cost of traveling.

35. The method of claim 28, comprising computing average frequencies of travel on each pair of origins and destinations; and producing the exposure data based on the computed average frequency of travel.

36. The method of claim 1, comprising:
ascertaining from the traffic data origin-destination data representing origins and destinations of trips of a population represented by the traffic data;
ascertaining whether each of the trips represented by the origin-destination data is a home-to-away trip, an away-to-home trip, or an away-to-away trip; and
producing trip data based on information ascertained by the second ascertaining step.

37. The method of claim 36, comprising calculating, for each respective pair of origin and destination transportation analysis zones comprising the geographic region, a number of trips traversed from the respective origin transportation analysis zone to the respective destination transportation analysis zone based on the trip data.

38. The method of claim 37, comprising ascertaining, from the calculated number of trips, a number of trips that represent a round trip by the same person.

39. The method of claim 37, comprising ascertaining a reach of each of a plurality of outdoor advertisements based on the calculated number of trips and the ascertained number of trips that represent a round trip by the same person.

40. The method of claim 1, comprising receiving modeled traffic data representing predicted movement data and calibrating the traffic data based on empirical traffic data.

41. The method of claim 40, comprising calibrating the modeled traffic data using outlier analysis.

42. The method of claim 40, comprising calibrating the modeled traffic data using a marginal weighting process.

43. The method of claim 40, comprising calibrating the modeled traffic data using a multilevel weighting process.

44. The method of claim 1, comprising ascertaining a home end of each trip represented by the traffic data; and producing demographic exposure data representing demographic distribution of outdoor advertising exposures based on demographic data and the ascertained home end of each trip.

45. The method of claim 44, comprising producing demographic exposure data based on an average vehicle occupancy rate of the geographic region.

46. The method of claim 44, comprising forming a trip chain for each trip not having a home end, each trip chain including the respective trip not having a home end and another trip extending from an origin or destination of the respective trip and a home; and producing the demographic exposure data based on each formed trip chain.

47. The method of claim 1, comprising producing road segment exposure data representing audience measurement estimates for a plurality of road segments within the geographic area based on the traffic data and the respondent data.

48. The method of claim 47, wherein the road segment exposure data includes data representing potential audience measurement estimates for road segments not having outdoor advertising.

49. The method of claim 1, comprising projecting estimates of exposures to the outdoor advertising beyond a time period of the study.

50. The method of claim 49, wherein projecting estimates of exposures utilizes a negative binomial model.

51. The method of claim 49, wherein projecting estimates of exposures includes estimating a probability of whether a person in a population is initially exposed to a selected outdoor advertisement for a first time during a target period beyond the time period of the study.

52. A method for estimating exposure to outdoor advertising, comprising:
receiving outdoor inventory data identifying locations of a plurality of outdoor advertisements within a geographic region;
receiving traffic data representing actual or predicted movement patterns of traffic within a geographic region; and
producing exposure data representing exposures to each of the outdoor advertisements based on the outdoor inventory data and the traffic data.

53. The method of claim 52, comprising wherein the outdoor inventory data includes at least one of a direction in which the respective outdoor advertisement faces and an amount of time per date the respective outdoor advertisement is visible.

54. The method of claim 52, comprising matching each of the outdoor advertisements to road segments within the geographic region.

55. The method of claim 52, comprising periodically receiving updated outdoor inventory data; and producing updated exposure data based on the updated outdoor inventory data.

56. The method of claim 52, comprising identifying each of the outdoor advertisements that is viewable from a plurality of road segments; and weighting each of the identified outdoor advertisements based on a likelihood of viewing the respective outdoor advertisement from each of said plurality of road segments.

57. A system for estimating exposure to outdoor advertising, comprising a processor operative to receive respondent data representing movements of participants in a study, operative to receive traffic data representing actual or predicted movement patterns of traffic within a geographic region, and operative to produce exposure data representing estimations of exposures to outdoor advertising based on the respondent data and the traffic data.

58. The system of claim 57, wherein the processor is operative to produce exposure data representing estimations of exposures of a population within the geographic region to the advertising based on the respondent data and the traffic data.

59. The system of claim 57, wherein the processor is operative to receive respondent data including demographic data pertaining to demographics of the participants; and to produce exposure data representing estimations of exposures to advertising broken down by demographic groups.

60.The system of claim 57, wherein the processor is operative to receive empirical traffic data and modeled traffic data, to compare the empirical traffic data and the modeled traffic data to produce compared traffic data; and to produce exposure data utilizing the compared traffic data.

61.The system of claim 57, wherein the processor is operative to produce exposure data representing estimations of exposures to advertising for selected time periods.

62.The system of claim 57, wherein the processor is operative to extend the geographic region represented by the traffic data to provide an extended geographic region, and to produce exposure data representing estimations of exposures to advertising within the extended geographic region based on the respondent data and the traffic data.

63. The system of claim 62, wherein the traffic data comprises data from a transportation model corresponding to the geographic region.

64. The system of claim 62, wherein the processor is operative to extend the geographic region based on trip counts within the geographic region, predefined transportation analysis zones of the geographic region and roadway segment types outside the geographic region.

65. The system of claim 62, wherein the processor is operative to project trip behavior represented within the traffic data to a geographic region extending beyond the geographic region represented by the traffic data.

66.The system of claim 62, wherein the respondent data represents movements of participants within the extended geographic region.

67. The system of claim 57, wherein the processor is operative to extract origin-destination data representing origins and destinations of trips from the traffic data for use in producing the exposure data.

68. The system of claim 67, wherein the processor is operative to exclude origin-destination data representing trips in which neither the origin nor the destination represents a home within an area of study represented by the exposure data.

69. The system of claim 57, further comprising portable monitors carried by the participants, the portable monitors adapted to track movements of the participants and to produce data from which the respondent data is produced.

70. The system of claim 57, wherein the processor is operative to receive respondent data representing road links traveled by the participants; and to produce records for each respondent identifying origins and destinations of trips by the respective respondent.

71. The system of claim 70, wherein the processor is operative to divide the geographic region into a plurality of transportation analysis zones; and to model relationships between the origins and destinations identified in the records and the transportation analysis zones.

72. The system of claim 70, wherein the processor is operative to predict frequencies that the respondents traverse selected road segments in a given period of time based on the respondent data and the produced records.

73. The system of claim 70, wherein the processor is operative to predict frequencies that the respondents traverse selected road segments in a given period of time based on a distance of the respective road segment to a home of the respective respondent.

74. The system of claim 70, wherein the processor is operative to predict frequencies that the respondents traverse selected road segments in a given period of time based on at least one of a number of persons in a household of the respective respondent, and a number of adults and children in a household of the respective respondent.

75. The system of claim 70, wherein the processor is operative to predict frequencies that the respondents traverse selected road segments in a given period of time based on at least one of an income of the respective respondent, a gender of the respective respondent, and an age of the respective respondent.

76. The system of claim 70, wherein the processor is operative to predict frequencies that the respondents traverse selected road segments in a given period of time based on at least one of a day of the week and a type of the respective road segment.

77. The system of claim 57, wherein the traffic data represents movement patterns of traffic over road segments represented in a geographically incorrect manner.

78. The system of claim 77, wherein the processor is operative to ascertain relationships between the road segments and each of a plurality of advertisements disposed at respective locations viewable from at least one road segment within the geographic area.

79. The system of claim 77, wherein the processor is operative to ascertain from the traffic data movement patterns of traffic over geographically correct road segments.

80. The system of claim 57, wherein the processor is operative to receive vehicle count data representing actual volume of traffic over specified road segments; and to produce exposure data representing estimations of exposures to advertising based on the respondent data, the traffic data and the vehicle count data.

81. The system of claim 57, wherein the processor is operative to receive census data representing information about a population within the geographic region; and to produce exposure data representing estimations of exposures to advertising by the population using the census data.

82. The system of claim 81, wherein the processor is operative to use data from a land use file of a transportation model to produce the exposure data.

83. The system of claim 82, wherein the land use file arranges land use data by transportation analysis zone, and the census data supplements the data of the land use file.

84. The system of claim 57, wherein the processor is operative to ascertain from the traffic data origin-destination data representing origins and destinations of trips of a population represented by the traffic data; and to produce exposure data based on the trip data and known locations of the outdoor advertising.

85. The system of claim 84, wherein the processor is operative to receive vehicle count data representing actual volume of traffic over specified road segments; and to revise the exposure data based on the vehicle count data.

86. The system of claim 85, wherein the processor is operative to periodically receive updated vehicle count data and to revise the exposure data based on the updated vehicle count data.

87. The system of claim 84, wherein the processor is operative to adjust the origin-destination data in accordance with a weight function based on a cost of traveling to produce adjusted origin-destination data.

88. The system of claim 87, wherein the weight function corresponds to at least one of a distance of the respective trip, a monetary cost of the respective trip; and a time of the respective trip.

89. The system of claim 87, wherein the weight function corresponds to at least two of a distance of the respective trip, a monetary cost of the respective trip, and a time of the respective trip.

90. The system of claim 84, wherein the processor is operative to adjust the origin-destination data in accordance with a reduction in a cost of traveling.

91. The system of claim 84, wherein the processor is operative to compute average frequencies of travel on each pair of origins and destinations; and to produce the exposure data based on the computed average frequency of travel.

92. The system of claim 57, wherein the processor is operative to ascertain from the traffic data origin-destination data representing origins and destinations of trips of a population represented by the traffic data; to ascertain whether each of the trips represented by the origin-destination data is a home-to-away trip, an away-to-home trip, or an away-to-away trip and to produce trip data based thereon.

93. The system of claim 92, wherein the processor is operative to calculate, for each respective pair of origin and destination transportation analysis zones comprising the geographic region, a number of trips traversed from the respective origin transportation analysis zone to the respective destination transportation analysis zone based on the trip data.

94. The system of claim 93, wherein the processor is operative to ascertain, from the calculated number of trips, a number of trips that represent a round trip by the same person.

95. The system of claim 93, wherein the processor is operative to ascertain a reach of each of a plurality of outdoor advertisements based on the calculated number of trips and the ascertained number of trips that represent a round trip by the same person.

96. The system of claim 57, wherein the processor is operative to calibrate the traffic data based on received empirical traffic data.

97. The system of claim 96, wherein the processor is operative to calibrate the modeled traffic data using outlier analysis.

98. The system of claim 96, wherein the processor is operative to calibrate the modeled traffic data using a marginal weighting process.

99. The system of claim 96, wherein the processor is operative to calibrate the modeled traffic data using a multilevel weighting process.

100. The system of claim 57, wherein the processor is operative to ascertain a home end of each trip represented by the traffic data; and to produce demographic exposure data representing demographic distribution of outdoor advertising exposures based on demographic data and the ascertained home end of each trip.

101. The system of claim 100, wherein the processor is operative to produce demographic exposure data based on an average vehicle occupancy rate of the geographic region.

102. The system of claim 100, wherein the processor is operative to form a trip chain for each trip not having a home end, each trip chain including the respective trip not having a home end and another trip extending from an origin or destination of the respective trip and a home; and to produce the demographic exposure data based on each formed trip chain.

103. The system of claim 57, wherein the processor is operative to produce road segment exposure data representing audience measurement estimates for a plurality of road segments within the geographic area based on the traffic data and the respondent data.

104. The system of claim 103, wherein the produced road segment exposure data includes data representing potential audience measurement estimates for road segments not having outdoor advertising.

105. The system of claim 57, wherein the processor is operative to project estimates of exposures to the outdoor advertising beyond a time period of the study.

106. The system of claim 105, wherein the processor projects estimates of exposures utilizing a negative binomial model.

107. The system of claim 105, wherein the processor projects estimates of exposures by estimating a probability of whether a person in a population is initially exposed to a selected outdoor advertisement for a first time during a target period beyond the time period of the study.

108. A system for estimating exposure to outdoor advertising, comprising a processor operative to receive outdoor inventory data identifying locations of a plurality of outdoor advertisements within a geographic region, operative to receive traffic data representing actual or predicted movement patterns of traffic within a geographic region, and operative to produce exposure data representing exposures to each of the outdoor advertisements based on the outdoor inventory data and the traffic data.

109. The system of claim 108, wherein the outdoor inventory data includes at least one of a direction in which the respective outdoor advertisement faces and an amount of time per date the respective outdoor advertisement is visible.

110. The system of claim 108, wherein the processor is operative to match each of the outdoor advertisements to road segments within the geographic region.

111. The system of claim 108, wherein the processor is operative to periodically receive updated outdoor inventory data; and to produce updated exposure data based on the updated outdoor inventory data.

112. The system of claim 108, wherein the processor is operative to identify each of the outdoor advertisements that is viewable from a plurality of road segments; and to weight each of the identified outdoor advertisements based on a likelihood of viewing the respective outdoor advertisement from each of said plurality of road segments.

113. A program for estimating exposure to outdoor advertising, the program residing in storage and operative to control a processor: to receive respondent data representing movements of participants in a study; to receive traffic data representing actual or predicted movement patterns of traffic within a geographic region; and to produce exposure data representing estimations of exposures to outdoor advertising based on the respondent data and the traffic data.

114. The program of claim 113, operative to control the processor to produce exposure data representing estimations of exposures of a population within the geographic region to the advertising based on the respondent data and the traffic data.

115. The program of claim 113, operative to control the processor to receive respondent data including demographic data pertaining to demographics of the participants; and to produce exposure data representing estimations of exposures to advertising broken down by demographic groups.

116. The program of claim 113, operative to control the processor to receive empirical traffic data and modeled traffic data, to compare the empirical traffic data and the modeled traffic data to produce compared traffic data; and to produce exposure data utilizing the compared traffic data.

117. The program of claim 113, operative to control the processor to produce exposure data representing estimations of exposures to advertising for selected time periods.

118. The program of claim 113, operative to control the processor to extend the geographic region represented by the traffic data to provide an extended geographic region, and to produce exposure data representing estimations of exposures to advertising within the extended geographic region based on the respondent data and the traffic data.

119. The program of claim 113, operative to control the processor to extract origin-destination data representing origins and destinations of trips from the traffic data for use in producing the exposure data.

120. The program of claim 113, operative to control the processor to receive respondent data representing road links traveled by the participants; and to produce records for each respondent identifying origins and destinations of trips by the respective respondent.

121. The program of claim 113, operative to control the processor to receive vehicle count data representing actual volume of traffic over specified road segments; and to produce exposure data representing estimations of exposures to advertising based on the respondent data, the traffic data and the vehicle count data.

122. The program of claim 113, operative to control the processor to receive census data representing information about a population within the geographic region; and to produce exposure data representing estimations of exposures to advertising by the population using the census data.

123. The program of claim 113, operative to control the processor to ascertain from the traffic data origin-destination data representing origins and destinations of trips of a population represented by the traffic data; and to produce exposure data based on the trip data and known locations of the outdoor advertising.

124. The program of claim 113, operative to control the processor to ascertain from the traffic data origin-destination data representing origins and destinations of trips of a population represented by the traffic data; to ascertain whether each of the trips represented by the origin-destination data is a home-to-away trip, an away-to-home trip, or an away-to-away trip and to produce trip data based thereon.

125. The program of claim 113, operative to control the processor to calibrate the traffic data based on received empirical traffic data.

126. The program of claim 113, operative to control the processor to ascertain a home end of each trip represented by the traffic data; and to produce demographic exposure data representing demographic distribution of outdoor advertising exposures based on demographic data and the ascertained home end of each trip.

127. The program of claim 113, operative to control the processor to produce road segment exposure data representing audience measurement estimates for a plurality of road segments within the geographic area based on the traffic data and the respondent data.

128. The program of claim 113, operative to control the processor to project estimates of exposures to the outdoor advertising beyond a time period of the study.

129. A program for estimating exposure to outdoor advertising, the program residing in storage and operative to control a processor: to receive outdoor inventory data identifying locations of a plurality of outdoor advertisements within a geographic region; to receive traffic data representing actual or predicted movement patterns of traffic within a geographic region; and to produce exposure data representing exposures to each of the outdoor advertisements based on the outdoor inventory data and the traffic data.

130. The program of claim 129, operative to control the processor to match each of the outdoor advertisements to road segments within the geographic region.

131. The program of claim 129, operative to control the processor to periodically receive updated outdoor inventory data; and to produce updated exposure data based on the updated outdoor inventory data.

132. The program of claim 129, operative to control the processor to identify each of the outdoor advertisements that is viewable from a plurality of road segments; and to weight each of the identified outdoor advertisements based on a likelihood of viewing the respective outdoor advertisement from each of said plurality of road segments.
